(19) United States
(12) Patent Application Publication
(10) Pub. No.: US 2009/0183384 A1
(43) Pub. Date: Jul. 23, 2009

(54) DRYING DEVICE

(75) Inventor: Hiroyasu Kitamura, Hirakata (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC WORKS, LTD., Osaka (JP)

(21) Appl. No.: 12/279,002

(22) PCT Filed: Jun. 26, 2007
(86) PCT No.: PCT/JP2007/062798

§ 371 Date: Aug. 11, 2008

(30) Foreign Application Priority Data
Jul. 10, 2006 (JP) 2006-189537

(51) Int. Cl. F26B 3/347

(52) U.S. Cl. 34/247

(57) ABSTRACT

A drying device has a heating coil 5a that heats by electromagnetic induction a material to be dried that is placed on a dried material-placement part, and an air blower 6 that sends air to the material to be dried. A heated member 22 heated by electromagnetic induction of the heating coil 5a and temperature detection means for detecting temperature of the heated member 22 are also provided. The heated member 22 is disposed at a position where the temperature thereof changes under the influence of the air from the air blower 6.

### TECHNICAL FIELD

The present invention relates to a drying device that dries a material to be dried by electromagnetic induction heating of a heating coil and also by air coming from an air blower.

### BACKGROUND ART

There has been known a drying device, such as the one disclosed in Japanese Patent Laid-Open No. 10-94685. This drying device, which treats as a material to be dried a blade part of an electric razor that has been cleaned with a cleansing liquid, heats this metallic blade part of the electric razor set in place by electromagnetic induction heating of a heating coil so as thereby to dry this blade part. Furthermore, in order to avoid the blade part from being excessively heated by the heating coil due to a circuit failure and the like, the drying device is provided with a temperature sensor in a housing that forms a casing of a main unit of the device, thereby to detect temperature of the blade part placed outside the housing indirectly therethrough and stop the electromagnetic induction heating of the heating coil when the detected temperature reaches a predetermined value or above.

According to the drying device disclosed in Japanese Patent Laid-Open No. 10-94685, the blade part, which is a material to be dried, is dried only by the electromagnetic induction heating of the heating coil, and therefore dry time becomes long. Furthermore, the temperature sensor has poor responsibility and is prone to cause measurement errors because it detects the temperature of the heated blade part indirectly through the housing. In this case, it is not possible to reliably prevent the blade part from being excessively heated by electromagnetic induction heating of the heating coil. Immediate contact of the temperature sensor with the blade part can solve the responsibility and measurement error problems, but in this case the temperature sensor is in danger of rust because it is in immediate contact with the blade part which gets wet, and furthermore, insulation between the temperature sensor and the blade part cannot be achieved.

The dry time of the material to be dried can be reduced by providing, for example, an air blower for sending air toward the material to be dried that is heated by electromagnetic induction heating, but the aforementioned problem of excessive heating of the material caused when a circuit failure occurs is not yet solved, and particularly when the air blower breaks down, the temperature of the material is rapidly increased by the electromagnetic induction heating, which is dangerous.

Disclosed in Japanese Patent Laid-Open No. 2003-308955 is a heating cooker using an electromagnetic induction method. This heating cooker has therein a heated member that is heated by electromagnetic induction heating of a heating coil, as means for estimating temperature of a material to be heated, thereby to detect temperature of the heated member directly by temperature detection means and prevent the material to be heated from being excessively heated by the heating coil based on the detection result. Therefore, in the case of directly detecting the temperature of the heated member heated by electromagnetic induction heating in the same way as the material to be heated, excessive heating of the material caused by a circuit failure can be detected immediately and hence prevented. This is, however, a heating cooking device, which, of course, has neither air blower for sending air to the material to be heated nor means for reliably preventing excessive heating of the material caused when a circuit failure occurs.

The present invention has been made in consideration of the foregoing conventional problems, and an object thereof is to provide a drying device that can dry a material to be dried in a short dry time by utilizing both electromagnetic induction heating of a heating coil and air from an air blower, offer improved responsibility and detection accuracy in temperature detection of the material to be dried with temperature detection means, prevent rust on the temperature detection means by keeping it from contact with the material to be heated which gets wet, achieve electrical insulation of the temperature detection means, and prevent excessive heating of the material to be heated that is caused when the air blower breaks down.

### DISCLOSURE OF INVENTION

In order to achieve the foregoing object, the drying device according to the present invention has a heating coil 5a that heats a material to be dried (blade part 2a in an embodiment) placed on a dried material-placement part by electromagnetic induction heating, and an air blower 6 that sends air to the material to be dried. The drying device is also provided with a heated member 22 that is heated by electromagnetic induction heating of the heating coil 5a, and temperature detection means for detecting temperature of the heated member 22. The heated member 22 is disposed at a position where the temperature thereof changes under influence of the air from the air blower 6. By providing the air blower 6, both the electromagnetic induction heating of the heating coil 5a and the air from the air blower 6 can be utilized to dry the material to be dried, and consequently dry time can be reduced. Also, by providing the heated member 22 heated by the electromagnetic induction heating of the heating coil 5a, the temperature detection means detects the temperature of the heated member 22, that is a substitute of the material to be dried, so as thereby to estimate the temperature of the material, thereby preventing the material from being excessively heated by the heating coil 5a based on the estimated temperature. Furthermore, the heated member 22 can be disposed away from the material to be dried, so that the heated member 22 and the temperature detection means for detecting the temperature thereof are not in contact with the wet material to be dried, and that they can be isolated from this material. In this case, the temperature detection means can be in immediate contact with the heated member 22 for the purpose of improving responsibility and measurement accuracy of the temperature detection. Furthermore, the heated member 22 is disposed at a position where the temperature thereof changes under the influence of the air from the air blower 6, and therefore, when the air blower 6 breaks down and accordingly the blade part 2a receiving no air is heated to high temperatures by the heating coil 5a, the temperature of the heated member 22 can be increased with a temperature rise of the material to be dried. This makes it possible to detect also the temperature rise of the material due to the breakdown of the air blower 6, and based on this detection, excessive heating of the material caused by the breakdown of the air blower 6 can be prevented.

Moreover, according to the drying device of the present invention, the heated member 22 is provided between the heating coil 5a and the dried material-placement part. This means that the heated member 22 can be disposed between the heating coil 5a and the material to be dried through which a magnetic flux produced by the heating coil 5a passes, thereby preventing variations in the temperature rise of the heated member 22 that are caused by displacements thereof relative to the heating coil 5a.

### BRIEF DESCRIPTION OF THE DRAWINGS

FIG. 1 is an example of an embodiment of the present invention, and is an explanatory view showing a state where an electric razor is set in a drying device.

FIG. 2 is an explanatory view of the drying device in the example.

FIG. 3 is a circuit diagram of an electromagnetic induction heating circuit block in the example.

FIG. 4 shows graphs for temperature changes of a temperature fuse and a blade part in the case that the blade part is dried using the drying device in the example, in which (a) is for when an air blower is operating normally and (b) is for when the air blower is stopped.

### BEST MODE FOR CARRYING OUT THE INVENTION

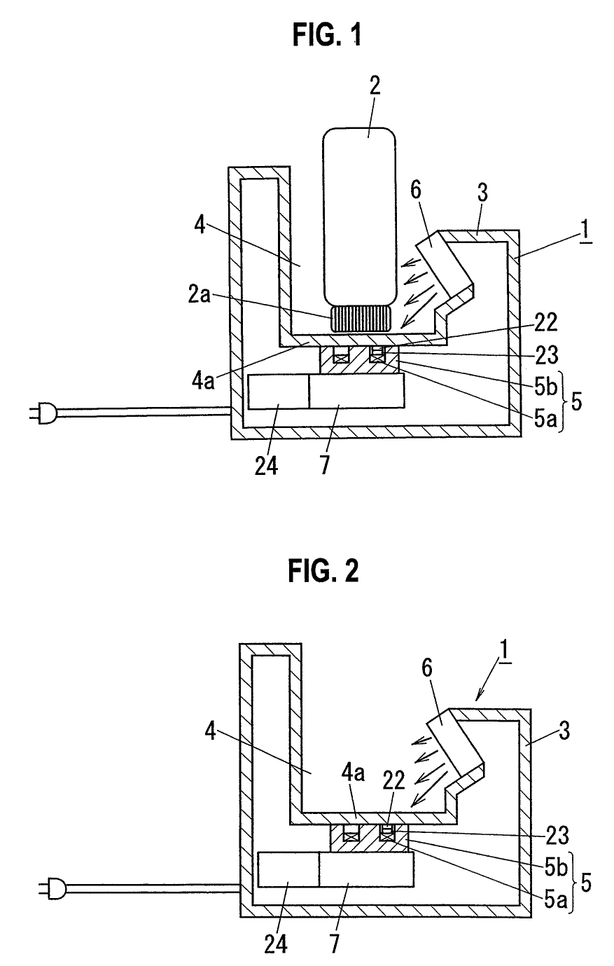

Referring to the accompanying drawings, there is shown an embodiment of the present invention. A drying device 1, which is an example of the embodiment shown in FIGS. 1 to 4, dries a metallic blade part 2a provided on a head portion of a conventional hand-held electric razor 2, by utilizing electromagnetic induction heating of a heating coil 5a and air from an air blower 6. A material to be dried by the drying device 1 is the blade part 2a of the electric razor 2.

In addition to means for drying the blade part 2a of the electric razor 2, the drying device 1 further has means for cleaning the blade part 2a with a cleansing liquid, and can therefore be used as a washer. For example, a series of a process of cleaning the blade part 2a of the electric razor 2 with the cleansing liquid and a subsequent process of drying the cleaned blade part 2a can be done only by this dying device 1.

As shown in FIG. 2, a storage recessed portion 4, which opens upward, is formed on an upper face part of a housing 3 that forms a casing of the drying device 1. In the storage recessed portion 4, the electric razor 2 can be received in such a manner that the blade part 2a thereof faces downward, as shown in FIG. 1. In this state, the blade part 2a of the electric razor 2 is placed in a lower part of the storage recessed portion 4. Note that the electric razor 2 received in the storage recessed portion 4 is fixed to the housing 3 at a predetermined position, which is not shown.

The storage recessed portion 4 is used as a washing tank that stores the cleansing liquid when the blade part 2a is cleaned. The blade part 2a of the electric razor 2 placed in the storage recessed portion 4 as described above is soaked in the cleansing liquid stored in the storage recessed portion 4, and then the electric razor 2 is caused to drive the blade part 2a, so that the blade part 2a of the electric razor 2 can be cleaned. Note that the drying device 1 has cleaning-liquid supply/discharge means, which is not shown, such as a pump used to supply the cleansing liquid into the storage recessed portion 4 and discharge the cleansing liquid therefrom.

Also at dry time, the storage recessed portion 4 is used to receive the electric razor 2. That is, the lower part of the storage recessed portion 4 is a dried material-placement part where the blade part 2a that is the material to be dried is placed. The following explanation will be given of the means for drying the blade part 2a of the electric razor 2.

The drying device 1 has an electromagnetic induction heater 5 and an air blower 6 as the means for drying the blade part 2a of the electric razor 2. The air blower 6 is disposed at an upper part of a side face of the storage recessed portion 4, and during operation thereof, it sends air from this position toward another opposite side face of the storage recessed portion 4. The air blower 6 provides an air flow obliquely downward, and when it is operated in a condition where the electric razor 2 is placed in the storage recessed portion 4 as shown in FIG. 1, the air from the air blower hits the blade part 2a of the electric razor 2 or a neighborhood thereof.

Meanwhile, the electromagnetic induction heater 5 is composed of the heating coil 5a and a core member 5b, and is disposed within the housing 3 so as to face an inner face of a bottom face part 4a of the storage recessed portion 4.

The electromagnetic induction heater 5 is provided to an electromagnetic induction heating circuit block 7 installed within the housing 3. By sending a high-frequency current about 100 kHz to the heating coil 5a from the electromagnetic induction heating circuit block 7, an eddy current is induced in the blade part 2a of the electric razor 2 because the blade part 2a stays on a magnetic path of a magnetic flux produced by the heating coil 5a, and as a result, electromagnetic induction heating can be made.

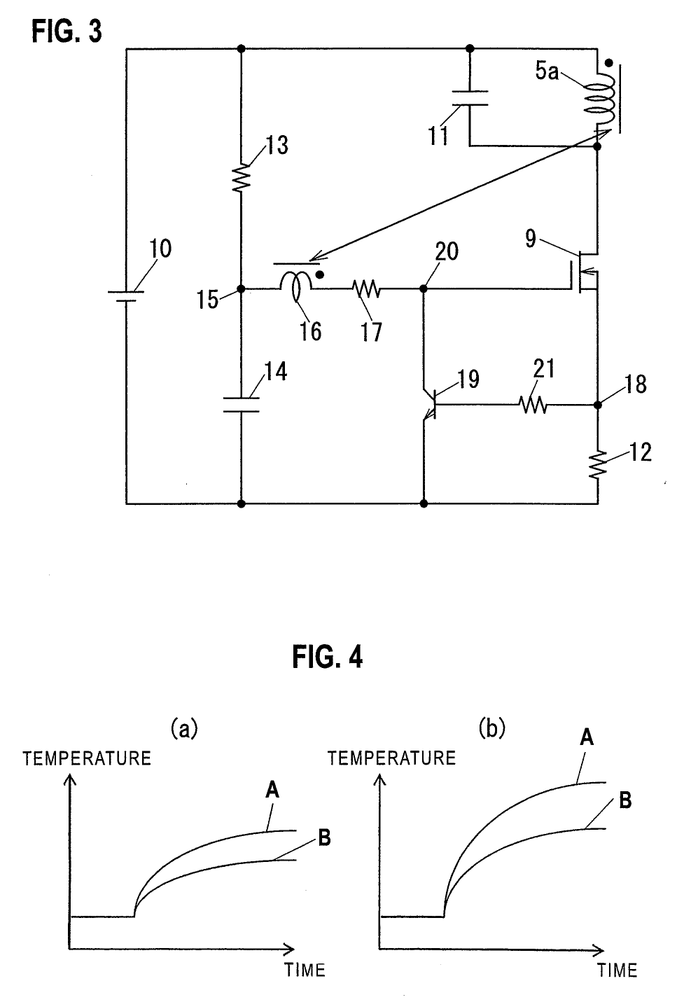

FIG. 3 is a circuit diagram of the electromagnetic induction heating circuit block 7. As shown in the drawing, a power source 10 is connected in series, each with a resonance circuit composed of the heating coil 5a and a capacitor 11, a switching element 9 composed of FETs, and a resistor 12. The power source 10 is also connected in series, each with a resistor 13 and a capacitor 14 so that the capacitor 14 is charged by electric power from the power source 10 through the resistor 13. A connecting point 15 between the resistor 13 and the capacitor 14 is connected to a gate of the switching element 9 via a feedback winding 16 and a resistor 17. A connecting point 18 between the switching element 9 and the resistor 12 is connected to a base of a transistor 19 via a resistor 21. An emitter and a collector of the transistor 19 are connected to the power source 10 and a connecting point 20 between the resistor 17 and the switching element 9, respectively. Therefore, when electric power is supplied from the power source 10, this circuit is oscillated, and thus electromagnetic induction heating of the heating coil 5a is performed. When the electric power supply is stopped, the electromagnetic induction heating of the heating coil 5a is terminated.

In order to dry the blade part 2a of the electric razor 2 using the drying device 1, the electric razor 2 is housed in the storage recessed portion 4 in which the cleansing liquid has been discharged, then a high-frequency current is sent to the heating coil 5a, and the air blower 6 is started at the same time. The blade part 2a of the electric razor 2 that is placed on the dried material-placement part in the lower part of the storage recessed portion 4 is then heated to high temperatures by electromagnetic induction heating of the heating coil 5a, and at the same time the air from the air blower 6 hits the blade part 2a. Also at this time, moist air in the storage recessed portion 4 is blown off by the air from the air blower 6 and dry air always flows into the storage recessed portion 4, thereby promoting drying of the blade part 2a of the electric razor 2.

In order to prevent excessive heating of the blade part 2a of the electric razor 2 by the heating coil 5a that is caused when the circuit or the air blower 6 breaks down at the dry time utilizing the electromagnetic induction heating and the air, the drying device 1 is provided with excessive heating prevention means, which will be described below.

In the housing 3, a metallic heated member 22 is provided as means for estimating temperature of the blade part 2a, which is a material to be dried. The heated member 22 is disposed between the heating coil 5a of the electromagnetic induction heater 5 and the bottom face part 4a of the storage recessed portion 4, and at the dry time of the blade part 2a of the electric razor 2, the magnetic flux produced by the heating coil 5a passes through the heated member 22. This heated member 22 is disposed in contact with the inner face of the bottom face part 4a of the storage recessed portion 4 where the air from the air blower 6 hits, or disposed in the neighborhood of the bottom face part 4a. Therefore, the temperature of the heated member 22 changes depending on temperature of the bottom face part 4a of the storage recessed portion 4. Accordingly, when both the electromagnetic induction heater 5 and the air blower 6 are activated for drying but the air from the air blower 6 does not hit the bottom face part 4a of the storage recessed portion 4 for some reasons, this affects the heated member 22, which means that the temperature thereof increases higher compared to the case that the air blower 6 is operating normally.

Between the heated member 22 disposed on the inner face of the bottom face part 4a and the heating coil 5a of the electromagnetic induction heater 5, a temperature fuse 23 is provided as temperature detection means, which is in immediate contact with the heated member 22 and is thermally connected thereto. Furthermore, when the temperature fuse 23 is heated above a predetermined temperature as the heated member 22 is heated, a controller 24 is designed to terminate the electromagnetic induction heating of the blade part 2a with the heating coil 5a based on information fed from the temperature fuse 23.

Therefore, when a high-frequency current is send to the heating coil 5a to dry the blade part 2a of the electric razor 2, the heated member 22 is heated, as in the same manner as the blade part 2a, by electromagnetic induction heating of the heating coil 5a and the temperature of the heated member 22 rises. When the electromagnetic induction heating of the heating coil 5a is terminated, the temperature of the heated member 22 falls. Therefore, when the blade part 2a is heated to high temperatures by the heating coil 5a because a circuit failure or the like occurs at the dry time, the heated member 22 is heated to high temperatures by the electromagnetic induction heating of the heating coil 5a, and accordingly the temperature fuse 23 is heated above the predetermined temperature. In response thereto, the controller 24 terminates the electromagnetic induction heating of the heating coil 5a thereby to prevent the blade part 2a from being excessively heated.

The heated member 22 is only required to be disposed where the magnetic flux of the heating coil 5a passes, so that the heated member 22 and the temperature fuse 23 for estimating the temperature of the blade part 2a can be placed away from the blade part 2a. Therefore, by disposing the heated member 22 and the temperature fuse 23 inside the housing 3 as described earlier, the cleansing liquid does not splash over them, and electrical insulation between them and the blade part 2a can be achieved by the housing 3. In this case, the temperature fuse 23 can be disposed in immediate contact with the heated member 22 that is heated directly by electromagnetic induction heating of the heating coil 5a, which makes it possible to promptly detect excessive heating of the blade part 2a of the electric razor 2, thereby reliably preventing the blade part 2a from being excessively heated by electromagnetic induction heating.

FIG. 4(a) is a graph showing temperature changes of the temperature fuse 23 and the blade part 2a during drying of the blade part 2a using the drying device 1 in a state where the air blower 6 is operating normally, and FIG. 4(b) is a graph showing temperature changes of the temperature fuse 23 and the blade part 2a during drying of the blade part 2a using the drying device 1 in a state where the air blower 6 is being stopped. In FIGS. 4(a) and 4(b), lines A and B denote temperature changes of the temperature fuse 23 and the blade part 2a, respectively.

As apparent from these graphs, when no air hits the blade part 2a because the air blower 6 stops, and consequently the blade part 2a is heated to high temperatures by the heating coil 5a, the temperature of the heated member 22 rises. This is because the heated member 22 is disposed just below the bottom face part 4a of the storage recessed portion 4 where the air from the air blower 6 hits. Thus, by providing the heated member 22 at a position where the temperature thereof changes under the influence of the air from the air blower 6, the temperature of the heated member 22 can be increased as the blade part 2a is heated to high temperature by the heating coil 5a because the air blower 6 breaks down and then no air hits the blade part 2a. Also in this case, the temperature fuse 23 is heated above the predetermined temperature, and accordingly the controller 24 terminates the electromagnetic induction heating of the heating coil 5a. Therefore, according to the present invention, also when the air blower 6 breaks down, it is possible to prevent the blade part 2a of the electric razor 2 from being heated excessively.

When the air from the air blower 6 hits the bottom face part 4a of the storage recessed portion 4, the temperature of the heated member 22 falls. This heated member 22 is provided to the inside of the housing 3 that the air from the air blower 6 does not hit directly, and therefore a temperature falling rate of the heated member 22 which is observed when the air is stopped is smaller than that of the blade part 2a of the electric razor 2 that directly receives the air. This enables the use of, for example, a temperature fuse 23 whose operating temperature is high, and thus eliminates the need of using a special temperature fuse whose operating temperature is below 80° C. Furthermore, operational errors of the temperature fuse 23 can be prevented reliably.

In this embodiment, the heated member 22 is disposed between the heating coil 5a and the dried material-placement part, so that the heated member 22 can be placed between the heating coil 5a and the material to be dried through which the magnetic flux produced by the heating coil 5a passes, thereby preventing variations in the temperature rise of the heated member 22 that are caused by displacements thereof relative to the heating coil 5a.

Note that the embodiment has been handled the case that the temperature detection means is the temperature fuse 23, but the temperature detection means can be a temperature sensor or other temperature detection devices. Furthermore, the present invention is applicable not only to the drying device 1 for drying the blade part 2a of the electric razor 2, but also to other drying devices which have already been known.

### INDUSTRIAL APPLICABILITY

According to the drying device of the present invention, both electromagnetic induction heating of a heating coil and air from an air blower can be utilized to dry a material to be dried, and also dry time can be reduced. Furthermore, in temperature detection of the material to be dried with temperature detection means, responsibility and detection accuracy thereof can be improved. Moreover, the temperature detection means can be kept from contact with the wet material to be dried thereby to prevent rust and achieve electrical insulation of the temperature detection means. Furthermore, it is possible to reliably prevent excessive heating of the material to be dried which occurs when the air blower breaks down.

In addition, according to the present invention, it is possible to stabilize the temperature rise of a heated member heated by the heating coil, which enables accurate estimation of the temperature of the material to be dried.

1. A drying device comprising:
a heating coil that heats a material to be dried by electromagnetic induction, the material being placed on a dried material-placement part;
an air blower that sends air to the material;
a heated member heated by electromagnetic induction of the heating coil; and
temperature detection means for detecting temperature of the heated member, wherein
the heated member is disposed at a position where temperature thereof changes under influence of the air from the air blower.

2. The drying device according to claim 1, wherein the heated member is disposed between the heating coil and the dried material-placement part.
